(19) United States
(12) Patent Application Publication
(10) Pub. No.: US 2013/0207761 A1
(43) Pub. Date: Aug. 15, 2013

(54) ELECTRICAL REACTOR WITH MAGNETIZATION

(71) Applicant: Alexander Mikhailovich Bryantsev, Moscow (RU)

(72) Inventor: Alexander Mikhailovich Bryantsev, Moscow (RU)

(73) Assignee: CIADOR ENTERPRISES LIMITED, Limassol (CY)

(21) Appl. No.: 13/700,946

(22) PCT Filed: Feb. 18, 2011
(86) PCT No.: PCT/RU10/00819

§ 371 Date: Feb. 7, 2013

(30) Foreign Application Priority Data
Jun. 2, 2010 (RU) 2010122442

(51) Int. Cl. H01F 27/00

(52) U.S. Cl. CPC H01F 27/00
USPC 336/5

(57) ABSTRACT

The invention relates to electrical engineering and is particularly suitable for use with magnetic-bias-controlled reactors installed, e.g., in an electric network to compensate for reactive power, regulate voltage, provide for parallel operation with capacitor banks, increase throughput, etc. A three-phase magnetic-bias-controlled reactor includes a magnetic system composed of vertical cores, horizontal yokes and magnetic shunts, as well as windings suitably placed on each core and windings wound around two adjacent cores, and a regulated DC voltage source. The magnetic system is spatial and includes two three-phase magnetic circuits located in parallel planes and installed between said magnetic circuits are additional sections of said yokes in the form of ferromagnetic inserts interconnecting said magnetic circuits through said horizontal yokes.

This invention relates to electrical engineering and is particularly suitable for use with magnetic-bias-controlled reactors installed, e.g., in an electric network to compensate for reactive power, regulate voltage, provide for parallel operation with capacitor banks, increase throughput, etc.

Known in the art is a magnetic-bias-controlled reactor [1] comprising a magnetic system with cores and yokes. Control windings suitably placed on the cores are connected in opposition and fed from a regulated DC voltage source. A power winding of each phase is wound around two adjacent cores with control windings. A disadvantage of [1] is an increased consumption of electrical steel of the magnetic system due to a large cross-section area of steel of the yoke sections located between the adjacent cores encircled by the power winding.

Also, known in the art is a magnetic-bias-controlled reactor [2] which has practically the same disadvantages. The reactor according to [2], which is a prototype of the herein claimed reactor, includes a magnetic system with cores and yokes. Control windings suitably placed on the cores are connected in opposition and fed from a regulated DC voltage source. A power winding of each phase is wound around two adjacent cores with control windings. One disadvantage of [2] is similar to that of [1], i.e., an increased consumption of electrical steel of the magnetic system due to a large cross-section area of steel of the yoke sections located between the adjacent cores encircled by the power winding. Another disadvantage of the prototype and prior art is a complex planar (located in the same plane) magnetic circuit having six cores and two side yokes. Reactors having such magnetic circuit are disproportionately lengthy, which not only complicates circuit manufacturing but also leads to increased consumption of structural materials.

Therefore, it is an object of the present invention to reduce electrical steel consumption and labor-intensity of production by improving said magnetic system and providing for an optimal ratio between cross-sections thereof.

This object is mainly accomplished by providing a three-phase magnetic-bias-controlled reactor comprising a magnetic system composed of vertical cores, horizontal yokes and magnetic shunts, as well as windings suitably placed on each core and windings wound around two adjacent cores, and a regulated DC voltage source, wherein said magnetic system according to the invention is made spatial and includes two three-phase magnetic circuits located in parallel planes. Installed between said magnetic circuits are additional sections of said yokes in the form of ferromagnetic inserts interconnecting said magnetic circuits through said horizontal yokes, with the cross-sections Sᵢₙₛ and S_{core} of steel of the ferromagnetic inserts and cores, respectively, connected through the following relation:

0.8<(Sᵢₙₛ:S_{core})<1.2.

Now the invention will be described with reference to a specific embodiment thereof taken in conjunction with the accompanying drawings, in which:

FIG. 1 is a magnetic circuit of the reactor spatial magnetic system comprising two core-type three-phase magnetic circuits;

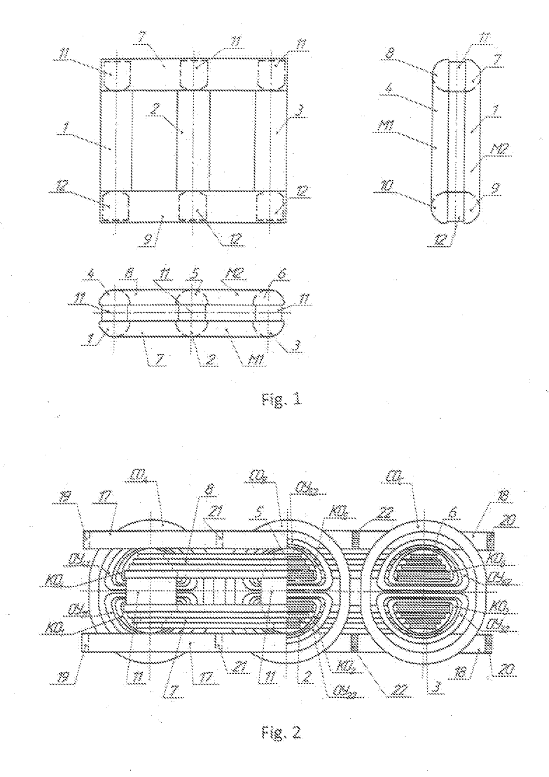

FIG. 2 illustrates layout of the windings on the cores;

FIG. 3 is a schematic winding connection diagram;

FIG. 4 illustrates an embodiment of the reactor without stabilizing windings;

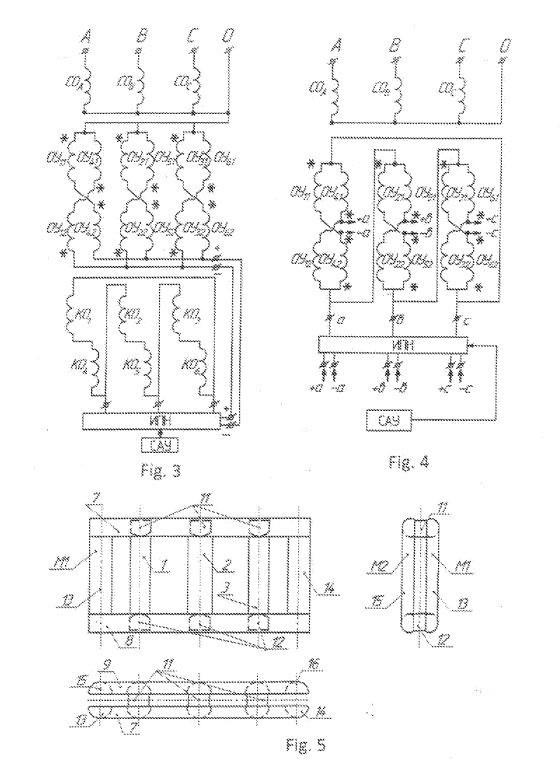

FIG. 5 is a spatial magnetic circuit made of two shell-type three-phase magnetic circuits;

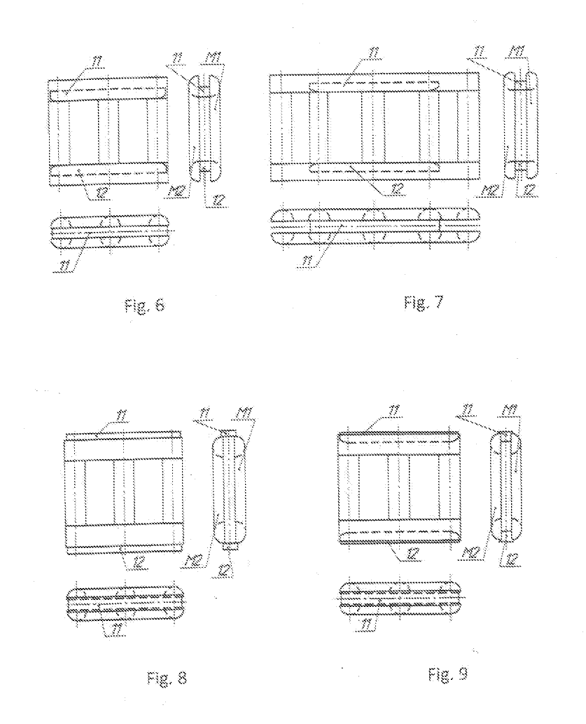

FIGS. 6 though 10 illustrate various embodiments of elongated ferromagnetic inserts.

The reactor magnetic system according to the invention comprises a spatial magnetic circuit, magnetic shunts, windings and structural elements.

The laminated spatial magnetic circuit (FIG. 1) made of electrical steel sheets is essentially composed of two planar core-type three-phase magnetic circuits M1 and M2 arranged in parallel planes. Each of the magnetic circuits M1 and M2 has three cores 1-3 and 4-6 and two horizontal yokes, i.e., upper 7, 8 and lower 9, 10. The magnetic circuits M1 and M2 are magnetically coupled to each other in the region of the horizontal yokes 7, 8 and 9, 10 with the aid of additional yoke sections in the form of ferromagnetic inserts 11 (at the top) and 12 (at the bottom). The ferromagnetic inserts may be laminated (made of structural steel sheets). The cross-section Sᵢₙₛ of steel of the ferromagnetic inserts and cross-section S_{core} of steel of the cores (1-6) are connected through the following relation:

0.8<(Sᵢₙₛ:S_{core})<1.2.

Each of the cores 1-6 is encircled by a stabilizing winding—stabilizing windings SW₁, SW₂, SW₃, SW₄, SW₅, SW₆—and a bank control winding—windings CW₁₁-CW₁₂, CW₂₁-CW₂₂, CW₃₁-CW₃₂, CW₄₁-CW₄₂, CW₅₁-CW₅₂, CW₆₁-CW₆₂ (FIGS. 2, 3). The first index denotes the number of a core and the second, the number of a section. Each control winding is divided into two sections and two sections of the control winding of the same phase are located on the adjacent cores.

Each two adjacent cores of the magnetic circuits M1 and M2 are encircled by a common winding: cores 1 and 4—by winding CW_{A}, cores 2 and 5—by winding PW_{B} and cores 3 and 6—by winding PW_{C}.

The power windings are star connected with neutral and coupled to lead-ins of the network phases A, B and C and neutral (0) lead-in (FIG. 3). The sections of the control winding of the adjacent cores encircled by the power windings are connected in an “incomplete delta” configuration (phase current difference connection) and coupled to a regulated DC voltage source (DCVS), i.e., a controlled rectifier. The three-phase DCVS includes a controlled semiconductor rectifier and receives power from the stabilizing windings. Each two SWs on the adjacent cores are series connected in pairs, i.e., SW₁-SW₄, SW₂-SW₅, SW₃-SW₆. The stabilizing windings are connected in a delta configuration with inlets a, b and c. The DCVS is controlled by an automatic control system (ACS).

Other embodiments of the herein proposed reactor configurations are also possible. The stabilizing winding may be made in the form of three windings each of which is wound around two adjacent cores (in the same manner as the power winding) and located inside it. A reactor embodiment may include no stabilizing windings and use the same connection of the power windings as shown in FIG. 3. In this case, the power windings PW_{A}, PW_{B} and PW_{C} should be interconnected and the DCVS controlled rectifier is powered from the network A, B, C or from an external source (e.g., from an auxiliary network of a substation) to which LC filters of higher harmonics are connected as well.

FIG. 4 illustrates still another embodiment of the reactor without stabilizing windings. In this case, the power windings are star connected with neutral and coupled to the network phases A, B and C in much the same manner as in FIG. 3 but the “incomplete delta” configurations of the control winding are connected in a complete delta configuration. The configuration of FIG. 4 where the DCVS is powered from the control windings uses a somewhat more intricate controlled rectifier.

Selection of a reactor configuration depends to a large extent on structural and process reasons and production capabilities. The important thing is that the selected configuration must include a delta connection and the power winding current (reactor current) must be free from higher harmonic multiple to three.

Instead of two planar core-type magnetic circuits shown in FIG. 1, the spatial magnetic circuit according to the invention may use two shell-type three-phase magnetic circuits M1 and M2 (FIG. 5) located in the parallel planes. Each of the magnetic circuit has three cores 1-3 and 4-6, two horizontal yokes (upper 7, 8 and lower 9, 10) and two vertical yokes 13, 14 and 15, 16. The magnetic circuits M1 and M2 are magnetically coupled to each other in the region of the horizontal yokes 7, 8 and 9,10 with the aid of additional yoke sections in the form ferromagnetic inserts 11 (at the top) and 12 (at the bottom).

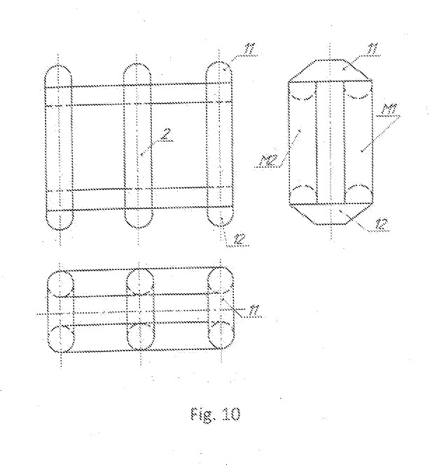

The inserts may be short and as wide as the cores (FIGS. 1 and 5) or elongated—along the yoke length between two outermost cores (FIGS. 6-10). A choice of a specific embodiment depends on structural reasons.

The magnetic system incorporates magnetic shunts.

A magnetic shunt may have a form of a rectangular laminated frame composed of electrical steel strips (FIG. 2). Two horizontal parts of the frame are located on the top end face of windings 17 and on the bottom end face of windings 18 under pressing beams, while vertical (longitudinal) parts 19 and 20 are located along the outermost windings as close as acceptable in terms of electrical insulation reliability. An additional shunt may be installed in a gap between two planar magnetic circuits forming the spatial magnetic circuit of the reactor according to the invention.

Also, the shunts may be made in the form of a three-window frame having two horizontal parts (lower part 17 and upper part 18) and four rather than two vertical parts 19-22, wherein two additional parts 21 and 22 are located in a space between the windings (FIG. 2). The cross-section Sₛₕᵤₙₜ of steel of shunt stacks vary from 5 to 20% of the core steel cross-section S_{core}.

Further, the magnetic shunts may be made as a set of flat shaped elements in the form of ring sectors fabricated from bands or strips of electrical steel (e.g., bonded with thermo-reactive resin). Such shunts are located on the end faces of the windings overlapping them as far as possible.

The magnetic system may be placed in a tank with a liquid coolant (e.g., transformer oil). The tank may also house the DCVS. The power lead-outs A, B and C are suitably installed on the tank cover. The delta taps a, b and c may also be arranged on the tank cover to connect the LC filters of higher harmonics (not shown in FIGS. 3 and 4). The magnetic shunts substantially in the form of vertical stacks of electrical steel strips may be installed on the internal surfaces of the tank walls.

The magnetic-bias-controlled reactor according to the invention functions as follows.

The power windings PW_{A}, PW_{B} and PW_{C} are connected to an AC power network. As this happens, an alternating magnetic flux starts flowing inside each power winding. Reactor power is controlled by connecting the bias windings CW₁₁-CW₁₂, CW₂₁-CW₂₂, CW₃₁-CW₃₂, CW₄₁-CW₄₂, CW₅₁-CW₅₂, CW₆₁-CW₆₂ to the DCVS. In this case, current with a DC component flows in the control windings whereby a time-invariant bias flux is set up in the cores. In the adjacent cores of the same phase this flux flows in opposite directions (since the control windings are opposite connected) and therefore the time-invariant flux mainly goes through the shortest path, i.e., additional sections in the form of the ferromagnetic inserts 11 and 12. The ferromagnetic inserts may be made of structural steel. Thus, electrical steel consumption for the herein proposed reactor is materially reduced as compared with the prototype and prior art. The cross-section Sᵢₙₛ of steel of the ferromagnetic inserts and the cross-section S_{core} of steel of the cores (1-6) are connected through the following relation:

0.8<(Sᵢₙₛ:S_{core})<1.2.

If the ratio (Sᵢₙₛ:S_{core}) is in excess of 1.2, steel consumption is excessively high. If the ratio (Sᵢₙₛ:S_{core}) is less than 0.8, the ferromagnetic insert will get saturated under a maximum load applied to the reactor and as a result the bias current will have to be increased. This ratio, like all other ratios in this specification, is a result of design calculations of reactor mathematical models and the results of such calculations may be submitted, if applicable, to the expertise.

Inasmuch as an AC current is superimposed on the bias flux, the resultant flux in the cores is biased to the saturation region, i.e., the cores remain saturated for a certain part of the period. Core saturation, in turn, causes current to flow through the power windings. This is a reactor operating current.

The constant magnetic flux is closed through the ferromagnetic inserts and therefore the magnetic flux in the horizontal yokes 7, 8, 9 and 10 (unlike the prior art and prototype) is free from any DC component. Thus, as distinct from the prior art and prototype, a smaller cross-section S_{yoke} of steel of the horizontal yokes 7, 8, 9 and 10 may be chosen. The cross-section S_{yoke} of yoke steel and the cross-section S_{core} of core steel are connected through the following relation:

1.0<(S_{yoke}:S_{core})<1.2.

A smaller cross-section of the yokes is the second advantage allowing electrical steel consumption in the herein proposed reactor to be materially reduced as compared with the prior art and prototype.

When the reactor operates, in addition to the magnetic field in steel of the cores and yokes, a leakage field caused by the winding current is set up in the region of the windings. The magnetic shunts concentrate the leakage field and prevent its spread to solid metal (not laminated) assemblies of the reactor, in which such field might otherwise cause unwanted eddy currents, stray load losses and local overheat dangerous to reactor operability. Besides, the magnetic shunts in the form of frames allow a main portion of a stray flux to be closed and decrease a magnetic load on the yokes, which adds to a reduced consumption of electrical steel.

Under no load conditions (no bias), only an alternating flux flows through the cores and yokes of the two magnetic circuits whereas no flux flows through the ferromagnetic inserts. When a load is applied, both alternating and constant magnetic fluxes flow through the cores, only the alternating flux flows through the yokes and shunts and only the constant magnetic flux flows through the ferromagnetic inserts. As regards the prior art and prototype, when a load is applied, both alternating and constant magnetic fluxes flow not only through the cores but also through the yokes and therefore a larger amount of electrical steel has to be used for the yokes. In the herein proposed reactor, the loads produced by the constant and alternating magnetic fluxes are divided between the yokes and ferromagnetic inserts whereby losses in steel are made lower and steel consumption is reduced, which means that the herein proposed device features higher technical and economic indices.

When the spatial magnetic circuit is formed of two shell-type three-phase magnetic circuits M1 and M2 (FIG. 5), the cross-sections S_{core} of steel of the cores are connected through the following relation:

(1/√3)<(S_{yoke}:S_{core})<(1, 2/√3), i.e., 0.58<(S_{yoke}:S_{core})<0.69.

This embodiment shall be preferred for high-power reactors because owing to smaller horizontal yokes the total height of the magnetic circuit may be decreased, which is important for the reactor to comply with clearance gage.

When the reactor operates in transient modes, (load increase and drop, load variations), core bias varies and hence the flux in the ferromagnetic inserts 11 and 12 varies too. As the flux varies, eddy currents occur in the insert steel opposing to flux variation. This phenomenon may degrade response of the reactor wherefore the ferromagnetic inserts made of structural steel should not be solid but should be made in the form of sheet stacks.

The herein proposed reactor has a number of advantages as compared with the prior art reactors and prototype. The reactor requires a smaller amount of electrical steel since part of electrical steel is replaced by cheaper structural steel (in the ferromagnetic inserts) and steel requirements for the yokes are decreased sine there are no DC component of the magnetic flux in said yokes. Labor-intensity of production of the magnetic system is materially reduced sine no multicore magnetic circuits are used and an optimum ratio is provided between cross-sections of the magnetic system component elements. A smaller amount of steel required reduces losses in steel and total losses in the reactor. As a result, higher technical and economic indices of the magnetic-bias-controlled reactor according to the invention are provided.

Operability of the reactor and high technical and economic indices thereof are proved by calculations, physical simulation and results of testing of prototype models of similar design. In the near future prototype models are planned to be manufactured for large-scale production.

### REFERENCES

1. Magnetic-Bias-Controlled Reactor. RF Patent 2217829, H01F29/14, H01F37/00, H01F38/02. Application: 2001134159/09, 19 Dec. 2001. Published: 27 Nov. 2003.
2. Magnetic-Bias-Controlled Reactor. RF Patent 2282911, H01F29/14. Application: 2004121197/09, 13 Jul. 2004. Published: 27 Aug. 2006.

What is claimed is:

1. A three-phase magnetic-bias-controlled reactor comprising a magnetic system composed of vertical cores, horizontal yokes and magnetic shunts, as well as windings suitably placed on each core and windings wound around two adjacent cores, and a regulated DC voltage source, characterized in that said magnetic system according to the invention is made spatial and includes two three-phase magnetic circuits located in parallel planes and installed between said magnetic circuits are additional sections of said yokes in the form of ferromagnetic inserts interconnecting said magnetic circuits through said horizontal yokes, with the cross-sections Sᵢₙₛ and S_{core} of steel of the ferromagnetic inserts and cores, respectively, connected through the following relation:
0.8<(Sᵢₙₛ:S_{core})<1.2.
